(19) United States
(12) Patent Application Publication
(10) Pub. No.: US 2026/0323529 A1
(43) Pub. Date: Oct. 15, 2026

(54) TRANSMISSION POWER CONTROL METHOD, APPARATUS, AND COMPUTER-READABLE STORAGE MEDIUM

(71) Applicant: ZTE Corporation, Shenzhen (CN)

(72) Inventors: Xing LIU, Shenzhen (CN); Xianghui Han, Shenzhen (CN); Xingguang Wei, Shenzhen (CN); Junfeng Zhang, Shenzhen (CN)

(73) Assignee: ZTE Corporation, Shenzhen (CN)

(21) Appl. No.: 19/532,866

(22) Filed: Feb. 6, 2026

Related U.S. Application Data
(63) Continuation of application No. PCT/CN2023/111797, filed on Aug. 8, 2023.

(51) Int. Cl. H04W 52/14; H04W 74/0833

(52) U.S. Cl. CPC H04W 52/146; H04W 74/0833

(57) ABSTRACT

A wireless communication method includes obtaining a first transmission power configuration; and determining a transmission power of a first uplink (UL) message based on the first power configuration and whether the first UL message is in a first UL resource. Another wireless communication method includes providing a first transmission power configuration; and receiving a first uplink (UL) message having a transmission power determined based on the first power configuration and whether the first UL message is in a first UL resource.

### TECHNICAL FIELD

This disclosure is generally related to wireless communication, and more particularly to transmission power control to mitigate the inference of transmission.

### BACKGROUND

Wireless communication technologies are pivotal components of the increasingly interconnecting global communication networks. Wireless communications rely on accurately allocated time and frequency resources for transmitting and receiving wireless signals. Although frequency duplication is a new technology to improve spectrum efficiency, simultaneous transmission on downlink (DL) and uplink (UL) will bring severe interference that may lead to design complexity of gNBs (base station, or BS) and user equipment (UE) and increase the costs.

### SUMMARY

This summary is a brief description of certain aspects of this disclosure. It is not intended to limit the scope of this disclosure.

According to some embodiments of this disclosure, a wireless communication method is disclosed. The method includes obtaining a first transmission power configuration; and determining a transmission power of a first uplink (UL) message based on the first power configuration and whether the first UL message is in a first UL resource.

According to some embodiments of this disclosure, another wireless communication method is disclosed. The method includes providing a first transmission power configuration; receiving a first uplink (UL) message having a transmission power determined based on the first power configuration and whether the first UL message is in a first UL resource.

Still another embodiment of this disclosure provides a wireless communication apparatus, including one or more memory units storing one or more programs and one or more processors electrically coupled to the one or more memory units and configured to execute the one or more programs to perform any method or step or their combinations in this disclosure.

Still another embodiment of this disclosure provides non-transitory computer-readable storage medium, storing one or more programs, the one or more programs being configured to, when performed by at least one processor, cause to perform any method or step or their combinations in this disclosure.

According to some embodiments of this disclosure, one or more wireless communication methods are further disclosed, the methods include combinations of certain methods, aspects, elements, and steps (either in a generic view or specific view) disclosed in the various embodiments of this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 shows a flowchart illustrating the competition-based random access procedure.

FIG. 2 shows a flowchart illustrating the non-competition-based random access procedure.

FIG. 3 shows a subband non-overlapping full duplex (SBFD) arrangement of transmission resources.

FIG. 4 shows a wireless communication system structure.

### DETAILED DESCRIPTION

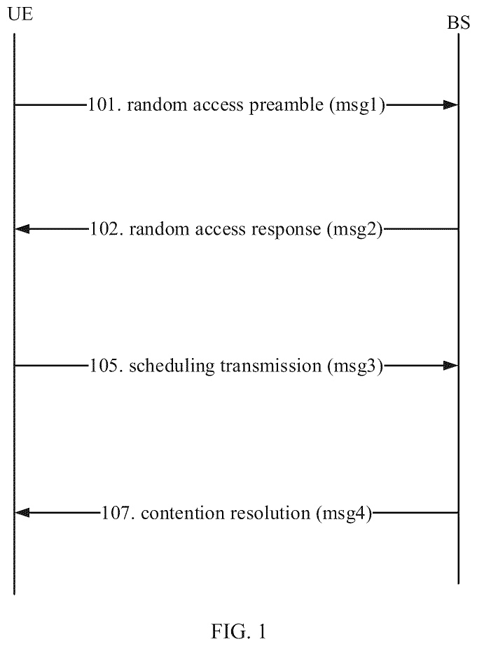

FIG. 1 shows a flowchart illustrating the competition-based random access procedure, and as shown in FIG. 1, the competition-based random access procedure mainly comprises the following steps:

S101: A UE transmits a random access preamble on a physical uplink random access channel (PRACH), wherein the time-frequency domain location for transmitting the preamble is associated with a Random Access Radio Network Temporary Identifier (RA-RNTI).

S103: After receiving the random access preamble, a base station replies a random access response to the UE on a physical downlink shared channel (PDSCH) which is scheduled by a physical downlink control channel (PDCCH), wherein the random access response comprises grant for subsequent uplink scheduling, i.e., Msg3 of the UE by the base station.

S105: If the UE identifies a response associated with the preamble transmitted in S101 according to the RA-RNTI, the UE performs the uplink scheduling according to the grant obtained from the base station in S103 and transmits an Msg3 to the base station. The Msg3 includes a UE identifier or a contention resolution identifier; if the message has not been received, the base station will reschedule the Msg3 through a DCI format with CRC scrambled by a Temporary Cell RNTI (TC-RNTI), then the UE retransmits the Msg3 according to the DCI format.

S107: After receiving the Msg3, the base station transmits an Msg4 to the UE according to the UE identifier; if the UE receives the message before a contention resolution timer is timeout and determines the Msg4 to be the Msg4 expected by the UE through unpacking, the UE determines that the random access procedure is successful; otherwise, the random access procedure is determined to be unsuccessful and a random access is reinitiated.

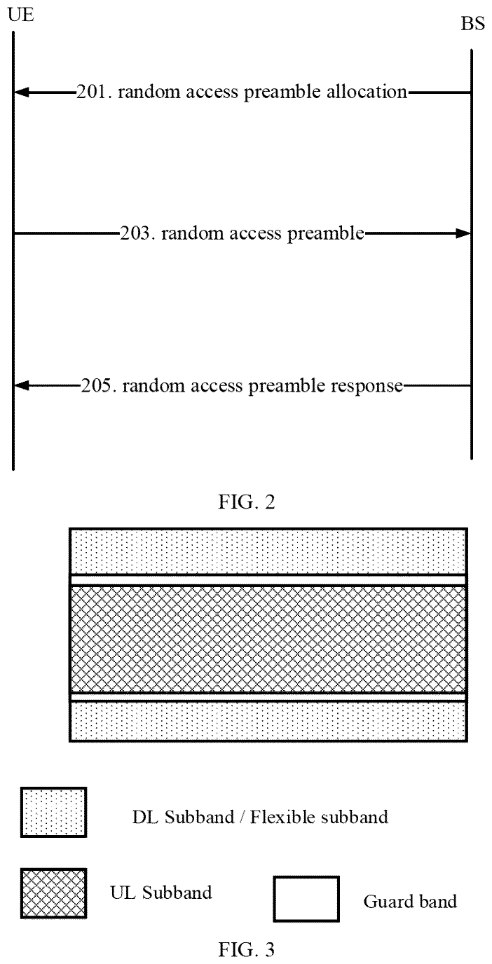

FIG. 2 shows a flowchart illustrating the non-competition-based random access procedure, and as shown in FIG. 2, the non-competition-based random access procedure mainly comprises the following steps (step S201 to step S205):

S201: The base station allocates a dedicated random access preamble for the UE through a dedicated signaling (e.g., a PDCCH order or an RRC signaling) firstly. A time-frequency domain location for transmitting the random access preamble is designated.

S203: The UE transmits the dedicated random access preamble in the designated time-frequency domain location.

S205: After receiving the random access preamble, the base station replies a random access response to the UE on the physical downlink shared channel (PDSCH) which is scheduled by a physical downlink control channel (PDCCH); if the UE identifies a response associated with the dedicated preamble transmitted in step S201, the UE determines that the random access procedure is successful; otherwise, the random access procedure is determined to be unsuccessful and another random access procedure is reinitiated.

Based on the current development trend, advanced wireless communication systems are developed with supports on features of enhanced mobile broadband (eMBB), ultra-reliable low-latency communication (URLLC), and massive machine-type communication (mMTC). Full duplex is a focused future of advanced wireless communication systems.

In wireless communication systems of TDD (Time Division Duplexing), time domain resources can be split between downlink and uplink. Allocation of a limited time duration for the uplink in TDD would result in reduced coverage, increased latency and reduced capacity. As a possible enhancement on this limitation of the conventional TDD operation, it would be worth studying the feasibility of allowing the simultaneous existence of downlink and uplink transmissions, or full duplex, or more specifically, subband non-overlapping full duplex (SBFD) at the gNB side within a conventional TDD band. Accordingly, a part of frequency resources will be configured as an uplink (UL) resource, or a UL subband, within a semi-static downlink (DL) resource or flexible resource. Alternatively or additionally, a part of frequency resource can be configured as DL resource, or a DL subband, within a semi-static UL resource or flexible resource. FIG. 3 shows an exemplary resource allocation of one time slot, where the UL subband is located with the DL resource. Either way, there will be both of uplink and downlink in different frequency domain resources of a same time domain resource.

Accordingly, there may be cross-link interference for the time-frequency resources with different attributes in the same time instance. For example, the DL transmission of one gNB (or base station, BS) in the DL resource may interfere with the uplink reception in the UL resource of the same gNB, as the DL resource and the UL resource are in the same time instance. The interference of the DL transmission to the UL reception is also called gNB self-interference under SBFD. It would be beneficial to have some improvement to overcome the potential interference under this arrangement of the transmission resources.

In a wireless communication system of TDD, the time domain resource may be divided into different attributes, such as downlink, uplink, and flexible resources (for example, among at least one of a frame, a slot, or a symbol). The above resource attributes can be configured or indicated by an RRC (Radio Resource Control) signaling or physical layer signaling, including downlink control information (DCI). For a SBFD system, a part of frequency domain resources can be configured as an uplink resource within the downlink or flexible resource (e.g., a downlink slot or a flexible slot) as shown in FIG. 3. The uplink resource within the downlink resource or flexible resource can be called as an UL subband, while the remaining downlink resource (excluding the UL subband from the downlink BWP (bandwidth part)) can be defined as a DL subband. Alternatively or additionally, a part of frequency domain resources can also be configured as a downlink resource within the uplink or flexible resource. The downlink resource can be defined as a DL subband. The remaining uplink resource (excluding the DL subband from the uplink BWP) can also be defined as a UL subband.

Different uplink transmissions (such as a PRACH, a PUSCH, an SRS) may be configured or indicated to be transmitted in the UL subband. For example, if a RACH procedure is allowed to be performed by using the UL subband resource, some PRACH resource, i.e., RO (RACH Occasion), may be defined within the UL subband. In addition, a msg3 PUSCH may be scheduled by a RAR (Random Access Request) UL grant for transmitting in the UL subband. To ensure the uplink transmission performance during the initial random access procedure, additional mechanisms may be considered for compensating the impact of base station's (BS) self-interference on uplink transmission performance.

For example, increasing the uplink transmission power is an approach to ensure the uplink transmission performance. For a single PRACH transmission, the transmission power can be determined using the following formula:

P_{PRACHb,f,c}(i)=min{P_{CMAX,f,c}(i),P_{PRACH,target,f,c}+PL_{b,f,c}} [dBm],
where P_{CMAX,f,c}(i) is the UE configured maximum output power, P_{PRACH,target,f,c} is the PRACH target reception power PREAMBLE_RECEIVED_TARGET_POWER.

The PREAMBLE_RECEIVED_TARGET_POWER is set to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA.

The preambleReceivedTargetPower is preamble Received Target Power configured via an RRC signaling. The DELTA_PREAMBLE values for different preamble formats is presented in Table 1 below as an example.

TABLE 1

| Preamble Format | DELTA_PREAMBLE values |
|---|---|
| 0 | 0 dB |
| 1 | −3 dB |
| 2 | −6 dB |
| 3 | 0 dB |

PREAMBLE_POWER_RAMPING_COUNTER is a counter that records the number of PRACH transmissions. PREAMBLE_POWER_RAMPING_STEP is the power increases for each retransmission configured via an RRC signaling. For example, the value of PREAMBLE_POWER_RAMPING_STEP is configured as 3 dB and the power of the first PRACH transmission is N dBm. Accordingly, the power of the first retransmission of PRACH or the second PRACH transmission will be N+3 dB. POWER_OFFSET_2STEP_RA is used for 2-step RACH transmission, the value of it will be 0 under 4-step RACH procedure.

For a msg3 PUSCH, the transmission power can be determined according to a cell specific parameter ‘msg3-DeltaPreamble’ or ‘deltaPreamble’ and the power of the PRACH transmission.

More specifically, P_{O_NOMINAL,PUSCH,f,c}(0)=P_{O_PRE}+Δ_{PREAMBLE,Msg3},
where P_{O_PRE} is provided by preambleReceivedTargetPower and Δ_{PREAMBLE_Msg3} is provided by msg3-DeltaPreamble or deltaPreamble. Alternatively, Δ_{PREAMBLE,Msg3}=0 dB, if msg3-DeltaPreamble and deltaPreamble are not provided for carrier f of serving cell c. Further, the actual value of the power offset between the msg3 PUSCH and PRACH may equal to field value of ‘msg3-DeltaPreamble’*2 [dB].

In addition, a 3-bit “TPC command for PUSCH” field in the RAR UL grant can also be used for further adjusting the power of a msg3 PUSCH scheduled by the RAR UL grant. The relationship between the value of “TPC command for PUSCH” field and value of power adjustment is given in Table 2.

TABLE 2

| TPC Command | Value (in dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

The following embodiments give some mechanisms on power control of uplink transmissions during initial access, such as, PRACH, msg3 PUSCH, etc.

### Power Enhancement for Msg1

According to some examples, if the PRACH transmission resource (for example, a RACH Occasion (RO)) is located within a UL subband, a different transmission power can be determined as compared with the case that the PRACH transmission resource is located out of a UL subband. An acceptable performance of PRACH transmission can be expected by the increase of the transmission power.

There can be different approaches for determining the initial power of PRACH transmission by considering the attribute of the PRACH transmission resource, RACH occasion (RO).

### Power Offset

According to some examples, if a RO is located within a UL subband, a power offset can be used for adjusting the initial power of a PRACH transmission. For example, the transmission power of PRACH can be determined according to the following formula:

P_{PRACH,b,f,c}(i)=min{P_{CMAX,f,c}(i),P_{PRACH,target,f,c}+PL_{b,f,c}+P_{offset}} [dBm].

P_{offset} is defined as the power offset for adjusting the transmission power of PRACH if a RO is located within a UL subband. The value of P_{offset} can be configured via an RRC signaling, such as system information block 1 (SIB1) or master information block (MIB). Alternatively, the value of P_{offset} can be pre-defined in a specification. Yet, if the RO is located out of a UL subband), P_{offset} can be determined as zero.

In some examples, if at least a part of resource of a RO is overlapping with the UL subband, it is considered the RO is located within the UL subband. On the other hand, if any part of resource of a RO is not overlapping with the UL subband, it is considered the RO is out of the UL subband. Alternatively, if the whole resource of a RO is within the UL subband, it is considered the RO is located within the UL subband. On the other hand, if at least a part of resource of a RO is not within the UL subband, it is considered the RO is out of the UL subband. The same understanding may be applicable to the whole of this disclosure.

Alternatively or additionally, P_{PRACH,target,f,c} (the PRACH target reception power) is set to preambleReceivedTargetPower+DELTA_PREAMBLE+ (PREAMBLE_POWER_RAMPING_COUNTER−1)×PREAMBLE_POWER_RAMPING_STEP+POWER_OFFSET_2STEP_RA+Power_offset.

In this equation, a power offset is added to compensate the interference. The value of Power_offset can be configured by a high layer signaling, such as an RRC signaling or a MAC layer signaling. Alternatively or additionally, the value of Power_offset can be pre-defined in a specification. The Power_offset is defined for adjusting the transmission power of a PRACH, if the RO is located within the UL subband. Alternatively, if the RO is located out of the UL subband, Power_offset is determined as zero.

preambleReceivedTargetPower

Alternatively or additionally, more than one values of a preamble received target power are configured by a first RRC parameter, such as “preambleReceivedTargetPower”. One of the values corresponds to a PRACH transmission using a RO within the UL subband, and another one of the value corresponds to a PRACH transmission out of the UL subband. Because P_{PRACH,target,f,c} is determined based on preambleReceivedTargetPower, the two values of preambleReceivedTargetPower can provide different values of P_{PRACH,target,f,c}.

Alternatively, only one value is configured by the first RRC parameter, but there can be a second parameter used to configure a power offset value. Accordingly, if a RO is located within a UL subband, the preamble received target power (“preambleReceivedTargetPower”) is determined as a sum of the value configured by the first RRC parameter and the value of power offset configured by the second parameter. Otherwise, if a RO is not located within a UL subband (or out of the UL subband), the preamble received target power (“preambleReceivedTargetPower”) is determined as the value configured by the first RRC parameter only. Alternatively or additionally, the second parameter can be predefined in a specification.

### DELTA_PREAMBLE

Additionally or alternatively, a set of new values of DELTA_PREAMBLE can be defined for a PRACH transmission using a RO within a UL subband. This set of values can be independent or distinct from those for a PRACH transmission using a RO out of a UL subband. In other words, there can be two sets of DELTA_PREAMBLE values respectively for PRACH transmission using ROs within and out of a UL subband.

Table 3 below shows an example of DELTA_PREAMBLE, where the set of DELTA_PREAMBLE values are defined for PRACH transmission for different preamble formats, respectively.

TABLE 3

| Preamble Format | DELTA_PREAMBLE values |
|---|---|
| 0 | 0 dB |
| 1 | −3 dB |
| 2 | −6 dB |
| 3 | 0 dB |

According to some examples as shown in in Table 4 below, more than one sets of DELTA_PREAMBLE values can be defined.

TABLE 4

| | DELTA_PREAMBLE values for | |
|---|---|---|
| | PRACH transmission without | |
| | using RO within the UL subband | DELTA_PREAMBLE values for |
| Preamble | (or using RO out of the UL | PRACH transmission using RO |
| Format | subband) | within the UL subband |
| 0 | 0 dB | 6 dB |
| 1 | −3 dB | 3 dB |
| 2 | −6 dB | 0 dB |
| 3 | 0 dB | 6 dB |

According to some embodiments, a higher value of DELTA_PREMBLE can be defined for a PRACH transmission using a RO within a UL subband. The UE transmitting PRACH by using a RO within the UL subband is likely to suffer a higher interference, so using a larger value of DELTA_PREAMBLE helps improve the PRACH transmission power more instantly to obtain a better coverage.

Alternatively or additionally, a set of DELTA_PREAMBLE values for a PRACH transmission using a RO within a UL subband can be deduced according to a set of DELTA_PREAMBLE values configured for a PRACH transmission using a RO out of a UL subband. For example, an offset (for example, with X dB) can be configured with signalling or be predefined. Accordingly, the DELTA_PREAMBLE value for a PRACH transmission using a RO within a UL subband can be determined by adding X dB to the configured DELTA_PREAMBLE value for a PRACH transmission using a RO out of a UL subband with the same preamble format. For example, X can be 6 dB. For preamble format 0, the DELTA_PREAMBLE value for a PRACH transmission using a RO within a UL subband can be determined as X+0=6 dB. For different PRACH formats, a same value of offset can be used. In some examples, different values of offset can be used for different PRACH formats.

### DCI Configuring

According to some examples, a RACH procedure can be initiated by a PDCCH order. The power offset can be indicated by an information field of a DCI format of the PDCCH order. The information field can be included in a DCI format, and the information field is used for indicating the value of power offset. For example, as shown in Table 5 below, N (e.g., 8) entries are defined in a specification or configured via an RRC signaling. Accordingly, an information field with ┌log₂ N┐ bits or log₂ N bits can be defined in a DCI format of the PDCCH order. The symbol ┌x┐ stands for a rounding up function to get the next integer of x. For example, ┌2.5┐=3. Additionally or alternatively, if the RO of PRACH transmission is located within the UL subband, the value of a power offset indicated by the information field can be used for determined the power of PRACH transmission. If a RO of a PRACH transmission is not located within the UL subband, the information field can be omitted.

TABLE 5

| | Value of power |
|---|---|
| Index | offset (in dB) |
| 0 | −6 |
| 1 | −4 |
| 2 | −2 |
| 3 | 0 |
| 4 | 2 |
| 5 | 4 |
| 6 | 6 |
| 7 | 8 |

Additionally or alternatively according to some examples, an information field can be defined in a DCI format of a PDCCH order. The information field is used for indicating whether an additional power offset should be used for determining the transmission power of a PRACH triggered by a PDCCH order. The additional power offset can be configured via a high layer signaling (such as an RRC signaling or a MAC (Medium Access Control) layer signaling) or a physical layer signaling (such as a DCI format of the PDCCH order).

Additionally or alternatively according to some examples, a RACH procedure can be initiated by a PDCCH order. A power offset can be indicated by an information field of a DCI format of the PDCCH order. If a RO of a PRACH transmission is located within a UL subband, the N MSB of a first information field can be used for indicating a power offset, where N is a positive integer. The first information field can be at least one of a Random Access Preamble index, an SS/PBCH index, or an PRACH Mask index.

In some examples above, two sets of the configurations can be provided for PRACH transmissions with ROs within or out of a UL subband, respectively. Alternatively or additionally, an offset can be introduced to add on top of regular PRACH transmission power. These measures may help overcome the interferences of the transmission using the UL subband.

### Power Ramping

Additionally or alternatively, improvement on the control of power ramping (on top of the initial transmission power) for uplink transmission may counteract inter-subband interference.

For a PRACH transmission, a power ramping counter can be used for counting a number of RACH attempts. A power ramping step size can be configured. If a first RACH attempt fails, UE may re-initiate the RACH procedure, or RACH reattempt, by using a higher transmission power. The higher transmission power can be determined according to the power ramping step size; for example, the power of the PRACH transmission in the RACH reattempt may be equal to a transmit power used during the previous PRACH transmission plus the power ramping step size.

For a PRACH transmission within a UL subband, an independent power ramping counter can be introduced. Accordingly, two independent or distinct power ramping counters can be used for PRACH transmissions using ROs within and out of a UL subband, respectively. As an example, C1 represents a power ramping counter for recording a number of PRACH attempts by using the PRACH transmission resource within the UL subband, and C2 represents another power ramping counter for recording a number of PRACH attempts by using the PRACH transmission resource out of the UL subband.

Additionally or alternatively, an independent or distinct power ramping step size can also be defined across different PRACH attempts by using the PRACH transmission resource within a UL subband. Accordingly, two independent or distinct power ramping step size configurations can be defined or configured for PRACH transmissions using ROs within and out of a UL subband, respectively. As an example, if a UE selects to transmit a PRACH by using a RO within the UL subband, the power ramping step size between different attempts=P1. Alternatively, if a UE selects to transmit a PRACH by using a RO out of the UL subband, the power ramping step size between different attempts=P2. As examples, P1 can be either larger or smaller than P2.

Additionally or alternatively, a UE can select different types of ROs (i.e., within a UL subband or out of a UL subband) for initiating RACH attempts. For example, a UE can select a RO within a UL subband for initiating a first RACH attempt. If the UE fails, the UE can select another RO out of the UL subband for re-initiating a second RACH attempt (or RACH reattempt). For the second RACH attempt, it is the first RACH attempt of using the RO out of the UL subband; the power ramping counter is set to one in response.

Accordingly, the power ramping value for each attempt can be determining according to the power ramping step sizes and power ramping counters. More specifically, independent or distinct power ramping step sizes and power ramping counters can be used for PRACH transmissions using ROs within and out of the UL subband, respectively. For example, the power ramping can be determined by the following formula:

(C1−1)×P1+(C2−1)×P2.

C1 and P1 represent power ramping counter and power ramping step size for a PRACH transmission using a RO within a UL subband. C2 and P2 represent power ramping counter and power ramping step size for PRACH transmission using RO out of a UL subband. An example is shown in Table 6, where the counters count the attempts separately, and the power ramping steps, P1 and P2, are configured separately.

TABLE 6

| Attempt | RO resource | power ramping value |
|---|---|---|
| 1 | Within UL subband | 0 |
| 2 | out of UL subband | 0 |
| 3 | Within UL subband | P1 |
| 4 | Within UL subband | 2*P1 |
| 5 | out of UL subband | P2 |
| 6 | out of UL subband | 2*P2 |
| . . . | . . . | . . . |

Thereby, the power ramping value for each attempt can be determined according to the power ramping step sizes and power ramping counters for each case respectively. Alternatively or additionally, there are different power ramping step sizes for a PRACH transmission using a RO within and out of a UL subband respectively, but a power ramping counter can be shared by two different cases. The power ramping value to be added on top of the power of the last PRACH transmission can be determined according to the type of the RO resource selected for a current RACH attempt.

An example is shown in Table 7, where P1 represents a power ramping step size for a PRACH transmission using a RO within a UL subband, and P2 represents a power ramping step size for a PRACH transmission using a RO out of a UL subband. As shown, the counter here is shared by two different types of RO selection, and the number of attempts is counted together, while the ramping steps are different.

TABLE 7

| Attempt | RO resource | Power ramping value |
|---|---|---|
| 1 | Within UL subband | 0 |
| 2 | out of UL subband | P2 |
| 3 | Within UL subband | P1 + P2 |
| 4 | Within UL subband | 2*P1 + P2 |
| 5 | out of UL subband | 2*P1 + 2*P2 |
| 6 | out of UL subband | 2*P1 + 3*P2 |
| . . . | . . . | . . . |

Additionally or alternatively according to some examples, a UE may be configured selection of ROs with a same type (for example, either within the UL subband or out of the UL subband) for different RACH attempts. For example, if a UE selects a RO within the UL subband for initiating a first RACH attempt, the UE may be configured to select a RO within the UL subband for subsequent RACH reattempt as well. Here, the power ramping configurations for the selected type of ROs may be applied. Likewise, a UE selects a RO out of the UL subband for initiating a first RACH attempt, the UE may be configured to select a RO out of the UL subband for subsequent RACH reattempt as well.

Additionally or alternatively according to some examples, if a PRACH repetition is configured, the PRACH transmissions within one RACH attempt may select ROs with a same type (either within the UL subband or out of the UL subband). A PRACH repetition referrers to a plurality of PRACH transmissions within one RACH attempt.

### SSB Selection

According to some examples for initiating a RACH procedure, UE can be configured with a threshold via an RRC parameter (e.g., rsrp-ThresholdSSB) for selecting an SSB (Synchronization Signal Block). For example, the UE may measure a SS-RSRP (Serving Cell Reference Signal Received Power) of an SSB. The UE can select one SSB with a SS-RSRP value larger than or equals to the threshold as configured for initiating the RACH procedure. If there is no SSB meeting such condition (for example, having an SS-RSRP larger than or equals to the threshold), the UE may alternatively select any SSB for initiating the RACH procedure. According to some examples, there is a relationship between an SSB and a RO according to a predefined rule. Accordingly, each RO may be associated with at least an SSB.

Additionally or alternatively, two thresholds may be configured for a SSB selection or a RO determination. One of the thresholds corresponds to the selection of a RO within a UL subband, and the other one corresponds to the selection of a RO out of the UL subband. Typically, the threshold corresponding to the selection of a RO within a UL subband is larger than the threshold corresponding to selection of a RO out of the UL subband. Then, if a SS-RSRP value of an SSB is larger than both of the two thresholds, and if a UE selects this SSB for initiating the RACH procedure, the UE can select a RO either within the UL subband or out of the UL subband. If a SS-RSRP value of an SSB is only larger than the threshold corresponding to RO out of UL subband, and if the UE selects this SSB for initiating the RACH procedure, the UE can only select RO out of the UL subband.

According to some examples, the two values of the thresholds can be configured by an RRC signaling, such as rsrp-ThresholdSSB. Alternatively or additionally, the two values of the thresholds can be configured by two or more different RRC signalings. Alternatively or additionally, one value of the thresholds can be configured by a RRC signaling, and the other one can be determined according to an offset, for example, by calculation based on a configured threshold value plus the offset. Exemplarily, the offset likewise can be configured via an RRC signaling or defined in a specification.

With the methods as described, the SSB selection mechanism for PRACH transmission using ROs within or out of the UL subband can be effectively defined in order to mitigate the interference of the UL transmission.

### Consideration of Transmission Power of PUSCH

According to some examples, a PUSCH scheduled by an RAR (Random Access Request) UL (uplink) grant can also be called as a msg3 PUSCH. The transmission power of a msg3 PUSCH can be determined according to a transmission power of a PRACH. For example, a value of Δ_{PREAMBLE_Msg3} can be provided by parameters msg3-DeltaPreamble or deltaPreamble, and the transmission power of msg3 PUSCH can be determined according to the transmission power of a PRACH and the value of Δ_{PREAMBLE_Msg3}.

According to some examples, two or more values of parameters msg3-DeltaPreamble or deltaPreamble can be provided by RRC signalings for determining the transmission power of msg3 PUSCH.

According to some examples, there can be four different values. For example, a first value is used for determining a transmission power of a msg3 PUSCH if both a corresponding PRACH and the msg3 PUSCH are transmitted within a UL subband. A second value is used for determining a transmission power of a msg3 PUSCH if a corresponding PRACH is transmitted within a UL subband while the msg3 PUSCH is transmitted out of a UL subband. A third value is used for determining the transmission power of a msg3 PUSCH if a corresponding PRACH is transmitted out of a UL subband and the msg3 PUSCH is transmitted within a UL subband. A fourth value is used for determining the transmission power of a msg3 PUSCH if both a corresponding PRACH and the msg3 PUSCH are transmitted out of a UL subband.

Alternatively or additionally, there can be three different values related to the transmission power settings. For example, a first value is used for determining the transmission power of a msg3 PUSCH if both a corresponding PRACH and the msg3 PUSCH are transmitted within the UL subband or both the corresponding PRACH and the msg3 PUSCH are transmitted out of the UL subband. A second value is used for determining the transmission power of a msg3 PUSCH if a corresponding PRACH is transmitted within a UL subband and the msg3 PUSCH is transmitted out of a UL subband. A third value is used for determining the transmission power of a msg3 PUSCH if a corresponding PRACH is transmitted out of a UL subband and the msg3 PUSCH is transmitted within a UL subband.

Alternatively or additionally in some examples, only msg3 PUSCHs are allowed to be scheduled within or out of a UL subband. On the other hand, PRACHs can only be transmitted on a RO out of a UL subband. Alternatively or additionally, there can be two different values related to transmission power settings. For example, a first value is used for determining the transmission power of a msg3 PUSCH if the msg3 PUSCH is transmitted within a UL subband. A second value is used for determining the transmission power of a msg3 PUSCH if the msg3 PUSCH is transmitted out of a UL subband.

Alternatively or additionally in some examples, only PRACHs are allowed to be transmitted within or out of a UL subband. Msg3 PUSCHs, on the other hand, can only be transmitted out of a UL subband. Alternatively or additionally, there can be two different values related to transmission power settings. For example, a first value is used for determining the transmission power of a msg3 PUSCH if a corresponding PRACH is transmitted within a UL subband. A second value is used for determining the transmission power of a msg3 PUSCH if a corresponding PRACH is transmitted out of the UL subband.

Alternatively or additionally in some examples, a value of Δ_{PREAMBLE_Msg3} (such as the parameters msg3-DeltaPreamble or deltaPreamble) and one or more values of an additional power offset can be configured by RRC signalings for determining a transmission power of a msg3 PUSCH.

Alternatively or additionally in some examples, a value of Δ_{PREAMBLE_Msg3} and a value of an additional power offset can be configured by RRC signalings. For example, if both a corresponding PRACH and a msg3 PUSCH are transmitted within a UL subband or both the PRACH and the msg3 PUSCH are transmitted out of a UL subband, the transmission power of the msg3 PUSCH is determined according to a value of Δ_{PREAMBLE_Msg3}. If the PRACH is transmitted within a UL subband and the msg3 PUSCH is transmitted out of a UL subband, the transmission power of msg3 PUSCH is determined according to a value of Δ_{PREAMBLE_Msg3} and a value of the additional power offset. For example, the transmission power of the msg3 PUSCH can be determined according to a value of Δ_{PREAMBLE_Msg3} minus a value of the additional power offset. Additionally or alternatively, if the PRACH is transmitted out of a UL subband and the msg3 PUSCH is transmitted within a UL subband, the transmission power of the msg3 PUSCH can be determined according to value of Δ_{PREAMBLE_Msg3} and the value of the additional power offset. For example, the power of the msg3 PUSCH can be determined according to value of Δ_{PREAMBLE_Msg3} plus the value of the additional power offset.

According to some examples as shown in Table 8, a value of ΔPREAMBLE Msg3 and two values of additional power offsets (for example, offset 1 and offset 2) can be configured by the RRC signalings. If both the PRACH and the msg3 PUSCH are transmitted within a UL subband or both the PRACH and the msg3 PUSCH are transmitted out of a UL subband, the power of msg3 PUSCH can be determined according to a value of Δ_{PREAMBLE_Msg3}. Alternatively or additionally, if the PRACH is transmitted within a UL subband and the msg3 PUSCH is transmitted out of a UL subband, the transmission power of msg3 PUSCH is determined according to value of Δ_{PREAMBLE_Msg3} and the value of offset1. For example, the transmission power of the msg3 PUSCH can be determined according to a value of Δ_{PREAMBLE_Msg3} minus a value of offset1. Alternatively or additionally, if the PRACH is transmitted out of a UL subband and the msg3 PUSCH is transmitted within a UL subband, the transmission power of the msg3 PUSCH can be determined according to a value of Δ_{PREAMBLE_Msg3} and a value of offset2. For example, the transmission power of a msg3 PUSCH can be determined according to a value of Δ_{PREAMBLE_Msg3} plus the value of offset 2.

TABLE 8

| Combination | Msg3 within UL subband | Msg3 out of UL subband |
|---|---|---|
| PRACH within | Δ_{PREAMBLE}_{_{—}}_{Msg3} | Δ_{PREAMBLE}_{_{—}}_{Msg3} − (minus) offset 1 |
| UL subband | | |
| PRACH out of UL | Δ_{PREAMBLE}_{_{—}}_{Msg3} + (plus) offset 2 | Δ_{PREAMBLE}_{_{—}}_{Msg3} |
| subband | | |

Accordingly, in some examples as disclosed, the determination of the transmission power of a msg3 PUSCH can be based on whether the msg3 PUSCH is within a UL subband and/or the corresponding PRACH is within a UL subband.

Alternatively or additionally according to some examples, msg3 PUSCHs are allowed to be scheduled within or out of the a subband, and PRACHs can only be transmitted on ROs out of a UL subband. According to these examples, a value of Δ_{PREAMBLE_Msg3} and a value of an additional power offset can be configured by RRC signalings to determine the transmission power. For example as shown in Table 9, if a msg3 PUSCH is transmitted within a UL subband, the transmission power of the msg3 PUSCH can be determined according to a value of Δ_{PREAMBLE_Msg3} plus a value of offset. Alternatively or additionally, if the msg3 PUSCH is transmitted out of a UL subband, the power of msg3 PUSCH is determined according to a value of Δ_{PREAMBLE_Msg3}.

TABLE 9

| Combination | Msg3 within UL subband | Msg3 out of UL subband |
|---|---|---|
| PRACH out of UL subband | Δ_{PREAMBLE}_{_{—}}_{Msg3} + offset | Δ_{PREAMBLE}_{_{—}}_{Msg3} |

Additionally or alternatively according to some examples, PRACHs are allowed to be transmitted within or out of a UL subband, and msg3 PUSCHs can only be transmitted out of a UL subband. Under such setting, a value of Δ_{PREAMBLE_Msg3} and a value of additional power offset can be configured by RRC signalings. For example as shown in Table 10, if a PRACH is transmitted within a UL subband, the transmission power of a corresponding msg3 PUSCH can be determined according to value of Δ_{PREAMBLE_Msg3} minus the value of an offset. Alternatively or additionally, if the PRACH is transmitted out of a UL subband, the transmission power of a msg3 PUSCH can be determined according to a value of Δ_{PREAMBLE_Msg3}.

TABLE 10

| Combination | PRACH within UL subband | PRACH out of UL subband |
|---|---|---|
| Msg3 out of UL subband | Δ_{PREAMBLE}_{_{—}}_{Msg3} − offset | Δ_{PREAMBLE}_{_{—}}_{Msg3} |

With the examples described above, the transmission power determination mechanism for msg3 PUSCHs can be effectively defined by considering the relationship of transmission resource of PRACH transmissions, transmissions of msg3 PUSCHs, and/or the UL subband.

### Transmission Power of PUSCH Scheduled by DCI Format

### Example 1

According to some examples, a PUSCH transmission is scheduled by a DCI format that includes an SRS resource indicator (SRI) field, and an open-loop power control parameter set indication field in the DCI format may include 2 bits. Additionally, there can be two different power control parameter sets, a first set and a second set. In the first set, there are more than one values of the power control parameters, and each value of the SRI field corresponds to one value of the power control parameters in the first set. In the second set, there can be more than one values of the power control parameters, and each value of the SRI field corresponds to two values of the power control parameters in the second set. For example, the power control parameters at least include a target received power, such as P0.

Additionally or alternatively according to some example, a first value of an open-loop power control parameter set indication field (such as “00”) indicates that a value of the power parameter (such as P0) used for determining the transmission power the PUSCH transmission can be selected from the first set of power control parameters according to the value of the SRI field. Additionally or alternatively, a second value of an open-loop power control parameter set indication field (such as “01”) indicates that the value of power parameter (such as P0) used for determining the transmission power the PUSCH transmission can be selected from the second set of power control parameter and that the value of power parameter is the first value corresponding to the SRI value. Additionally or alternatively, a third value of an open-loop power control parameter set indication field (such as “10”) indicates that the value of the power parameter (P0) used for determining the transmission power the PUSCH transmission can be selected from the second set and that the value of power parameter is the second value corresponding to the SRI value.

### Example 2

Additionally or alternatively according to some examples, a PUSCH transmission is scheduled by a DCI format that includes an SRS resource indicator (SRI) field, and an open-loop power control parameter set indication field in the DCI format includes 2 bits. In some examples, there are two different power control parameters sets, a first set and a second set. In the first set, there are more than one values of the power control parameters, and each value of SRI field corresponds to one value of the power control parameters in the first set. In the second set, there are more than one values of the power control parameters, and each value of the SRI field corresponds to three values of the power control parameters in the second set. The power control parameters at least include a target received power (“P0”).

According to some examples, a first value of the open-loop power control parameter set indication field (“00” for example) indicates that the value of power parameter (P0 for example) used for determining the transmission power the PUSCH transmission is selected from the first set according to the value of the SRI field. A second value of the open-loop power control parameter set indication field (for example, “01”) indicates that the value of the power parameter (“P0” for example) used for determining the transmission power the PUSCH transmission is selected from the second set and that the value of the power parameter is the first value corresponding to the SRI value. A third value of an open-loop power control parameter set indication field (for example, “10”) indicates that the value of power parameter (for example, P0) used for determining the transmission power the PUSCH transmission is selected from the second set and that it is the second value corresponding to the SRI value. A fourth value of an open-loop power control parameter set indication field (such as “11”), indicates that the value of power parameter (such as P0) used for determining the transmission power the PUSCH transmission is selected from the second set and that it is the third value corresponding to the SRI value.

### Example 3

Additionally or alternatively according to some examples, a PUSCH transmission is scheduled by a DCI format that includes an SRS resource indicator (SRI) field, and an open-loop power control parameter set indication field in the DCI format includes 2 bits. In some examples, there are two different power control parameters sets, a first set and a second set. For the first set, there are more than one values of the power control parameters, and each value of the SRI field corresponds to two values of the power control parameters in the first set. For the second set, there are more than one value of the power control parameters, and each value of the SRI field corresponds to two values of the power control parameters in the second set. The power control parameters at least include a target received power (“P0”).

According to some examples, a first value of an open-loop power control parameter set indication field (e.g., “00”) indicates that the value of the power parameter (e.g., P0) used for determining the transmission power the PUSCH transmission is selected from the first set and that it is the first value corresponding to the SRI value. A second value of an open-loop power control parameter set indication field (e.g., “01”) indicates that the value of the power parameter (e.g., P0) used for determining the transmission power the PUSCH transmission is selected from the first set and that it is the second value corresponding to the SRI value. A third value of an open-loop power control parameter set indication field (e.g., “10”) indicates that the value of the power parameter (e.g., P0) used for determining the transmission power the PUSCH transmission is selected from the second set and that it is the first value corresponding to the SRI value. A fourth value of an open-loop power control parameter set indication field (e.g., “11”) indicates that the value of the power parameter (e.g., P0) used for determining the transmission power the PUSCH transmission is selected from the second set and that it is the second value corresponding to the SRI value.

### Example 4

Additionally or alternatively according to some examples, a PUSCH transmission is scheduled by a DCI format that does not include an SRS resource indicator (SRI) field, and an open-loop power control parameter set indication field in the DCI format includes 2 bits. In some examples, there are two different power control parameter sets, a first set and a second set. For the first set, there are more than one values of the power control parameters. For the second set, there are more than one groups of values of the power control parameters, and there are at least three values in each group of values. The power control parameters at least include a target received power (“P0”).

In some examples, a first value of an open-loop power control parameter set indication field (e.g., 00) indicates that a first value of a first set is selected for determining the transmission power the PUSCH transmission. A second value of an open-loop power control parameter set indication field (e.g., ‘01’) indicates that the first value of the first group of values is selected for determining the transmission power the PUSCH transmission from the second set. A third value of an open-loop power control parameter set indication field (e.g., ‘10’) indicates that the second value of the first group of values is selected for determining the transmission power the PUSCH transmission from the second set. A fourth value of an open-loop power control parameter set indication field (e.g., ‘11’) indicates that the third value of the first group of values is selected for determining the transmission power the PUSCH transmission from the second set and that it is the third value of the first group of values.

### Example 5

Additionally or alternatively according to some examples, a PUSCH transmission is scheduled by a DCI format that does not include an SRS resource indicator (SRI) field, and an open-loop power control parameter set indication field in the DCI format includes 2 bits. In some examples, there are two different power control parameter sets, a first set and a second set. For the first set, there are more than one groups of values of the power control parameters, and there are at least two values in each group of values. For the second set, there are more than one groups of values of the power control parameters, and there are at least two values in each group of values. The power control parameters at least include a target received power (“P0”).

In some examples, a first value of an open-loop power control parameter set indication field (e.g., ‘00’) indicates that the first value of the first group of values is selected for determining the transmission power the PUSCH transmission from the first set. A second value of an open-loop power control parameter set indication field (e.g., ‘01’) indicates that the second value of the first group of values is selected for determining the transmission power the PUSCH transmission from the first set. A third value of an open-loop power control parameter set indication field (‘10’) indicates that the first value of the first group of values is selected for determining the transmission power the PUSCH transmission from the second set. A fourth value of an open-loop power control parameter set indication field (e.g., ‘11’) indicates that the second value of the first group of values determining the transmission power the PUSCH transmission from the second set.

With the method described above, the power determination mechanism for a PUSCH scheduled by a DCI format can be effectively defined.

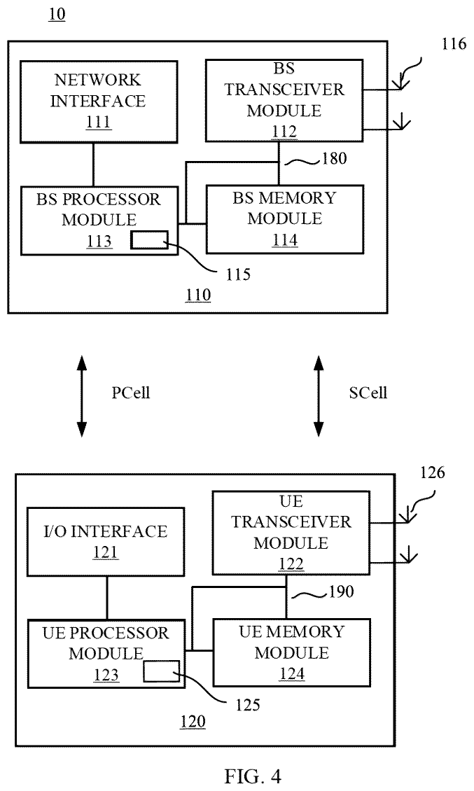

FIG. 4 illustrates a block diagram of an exemplary wireless communication system 10, in accordance with some embodiments of this disclosure. The system 10 may perform the methods/steps and their combination disclosed in this disclosure. The system 10 may include components and elements configured to support operating features that need not be described in detail herein.

The system 10 may include a base station (BS) 110 and user equipment (UE) 120. The BS 110 includes a BS transceiver or transceiver module 112, a BS antenna system 116, a BS memory or memory module 114, a BS processor or processor module 113, and a network interface 111. The components of BS 110 may be electrically coupled and in communication with one another as necessary via a data communication bus 180. Likewise, the UE 120 includes a UE transceiver or transceiver module 122, a UE antenna system 126, a UE memory or memory module 124, a UE processor or processor module 123, and an I/O interface 121. The components of the UE 120 may be electrically coupled and in communication with one another as necessary via a data communication bus 190. The BS 110 communicates with the UE 120 via communication channels therebetween, which can be any wireless channel or other medium known in the art suitable for transmission of data as described herein. The channels may include carriers of PCells and SCells.

The processor modules 113, 123 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module performed by processor modules 113, 123, respectively, or in any practical combination thereof. The memory modules 113, 123 may be realized as RAM memory, flash memory, EEPROM memory, registers, ROM memory, EPROM memory, a hard disk, a removable disk, a CD-ROM, or any other form of storage medium known in the art. In this regard, the memory modules 114, 124 may be coupled to the processor modules 113, 123 respectively, such that the processors modules 113, 123 can read information from, and write information to, memory modules 114, 124 respectively. The memory modules 114, 124 may also be integrated into their respective processor modules 113, 123. In some embodiments, the memory modules 114, 124 may each include a cache memory for storing temporary variables or other intermediate information during execution of instructions to be performed by processor modules 113, 123, respectively. The memory modules 114, 124 may also each include non-volatile memory for storing instructions to be performed by the processor modules 113, 123, respectively.

According to some embodiments of this disclosure, a wireless communication method is disclosed. The method including: obtaining a first transmission power configuration; and determining a transmission power of a first uplink (UL) message based on the first power configuration and whether the first UL message is in a first UL resource.

According to some embodiments, the first UL resource occupies at least a part of a frequency domain resource of a downlink (DL) resource or a flexible resource; and/or the first UL message is a preamble transmitted on a Physical Random Access Channel (PRACH).

According to some embodiments, according to the first transmission power configuration, the first UL message has a first transmission power when it is in the first UL resource different from a second transmission power when it is out of the first UL resource.

According to some embodiments, the first transmission power configuration includes a first power offset for a first UL message in the first UL resource in addition to a transmission power of a first UL message out of the first UL resource; and/or the first transmission power configuration includes a PRACH target reception power having a second power offset for a first UL message in the first UL resource than a first UL message out of the first UL resource; and/or the first transmission power configuration includes a first target reception power value for a first UL message in the first UL resource and a second target reception power value for a first UL message out of the first UL resource; and/or the first transmission power configuration includes a first Delta_Preamble setting for a first UL message in the first UL resource and a second Delta_Preamble setting for a first UL message out of the first UL resource; and/or the first transmission power configuration is indicated by a PDCCH with an offset value for the first UL message in the first UL resource.

According to some embodiments, the first transmission power configuration includes a first power ramping setting for a first UL message in the first UL resource and a second power ramping setting for a first UL message out of the first UL resource.

According to some embodiments, the power ramping setting includes at least one of a power ramping counter or a power ramping step size for the first UL message.

According to some embodiments, the method further includes determining a power ramping value for a first UL message according to the power ramping setting corresponding to a resource for the first UL message.

According to some embodiments, the method further includes selecting a first RACH occasion (RO) and at least one second RO for different RACH attempts, wherein whether the at least one second RO is within or out of a first UL resource is based on whether the first RO is within or out of a first UL resource.

According to some embodiments, the method further includes selecting at least one SSB (Synchronization Signal Block) based on an SSB selection configuration, the SSB selection configuration including a first threshold for selecting of an SSB corresponding to an RO within the first UL resource and a second threshold for selection of an SSB corresponding to an RO out of the first UL resource.

According to some embodiments, the method further includes determining a transmission power of a second UL message based on the transmission power of the first UL message and a second transmission power configuration, wherein the second transmission power configuration includes two or more values of power difference between the first UL message and the second UL message; and/or the second transmission power configuration includes a value of power difference between the first UL message and the second UL message and one or more offset.

According to some embodiments of this disclosure, another wireless communication method is disclosed. The method includes providing a first transmission power configuration; and receiving a first uplink (UL) message having a transmission power determined based on the first power configuration and whether the first UL message is in a first UL resource.

According to some embodiments, the first UL resource occupies at least a part of a frequency domain resource of a downlink (DL) resource or a flexible resource; and/or the first UL message is a preamble transmitted on a Physical Random Access Channel (PRACH).

According to some embodiments, according to the first transmission power configuration, the first UL message has a first transmission power when it is in the first UL resource different from a second transmission power when it is out of the first UL resource.

According to some embodiments, the first transmission power configuration includes a first power offset for a first UL message in the first UL resource in addition to a transmission power of a first UL message out of the first UL resource; and/or the first transmission power configuration includes a PRACH target reception power having a second power offset for a first UL message in the first UL resource than a first UL message out of the first UL resource; and/or the first transmission power configuration includes a first target reception power value for a first UL message in the first UL resource and a second target reception power value for a first UL message out of the first UL resource; and/or the first transmission power configuration includes a first Delta_Preamble setting for a first UL message in the first UL resource and a second Delta_Preamble setting for a first UL message out of the first UL resource; and/or the first transmission power configuration is indicated by a PDCCH with an offset value for the first UL message in the first UL resource.

According to some embodiments, the first transmission power configuration includes a first power ramping setting for a first UL message in the first UL resource and a second power ramping setting for a first UL message out of the first UL resource.

According to some embodiments, the power ramping setting includes at least one of a power ramping counter or a power ramping step size for the first UL message.

According to some embodiments, the method further includes receiving the first UL message have the transmission power determined according to a power ramping value for the first UL message according to the power ramping setting corresponding to a resource for the first UL message.

According to some embodiments, the method further includes receiving the first UL message in a first RACH occasion (RO) and at least one second RO for different RACH attempts, wherein whether the at least one second RO is within or out of a first UL resource is based on whether the first RO is within or out of a first UL resource.

According to some embodiments, the method further includes comprising an SSB selection configuration for selecting at least one SSB (Synchronization Signal Block) providing, the SSB selection configuration including a first threshold for selecting of an SSB corresponding to an RO within the first UL resource and a second threshold for selection of an SSB corresponding to an RO out of the first UL resource.

According to some embodiments, the method further includes receiving a second UL message having a transmission power determined based on the transmission power of the first UL message and a second transmission power configuration, wherein the second transmission power configuration includes two or more values of power difference between the first UL message and the second UL message; and/or the second transmission power configuration includes a value of power difference between the first UL message and the second UL message and one or more offset.

According to some embodiments, the method further includes the second UL message is a PUSCH message.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
obtaining a first transmission power configuration; and
determining a transmission power of a first uplink (UL) message based on the first power configuration and whether the first UL message is in a first UL resource.

2. The method of claim 1, wherein:
the first UL resource occupies at least a part of a frequency domain resource of a downlink (DL) resource or a flexible resource; and/or
the first UL message is a preamble transmitted on a Physical Random Access Channel (PRACH).

3. The method of claim 1, wherein, according to the first transmission power configuration, the first UL message has a first transmission power when it is in the first UL resource different from a second transmission power when it is out of the first UL resource.

4. The method of claim 1, wherein:
the first transmission power configuration includes a first power ramping setting for a first UL message in the first UL resource and a second power ramping setting for a first UL message out of the first UL resource; and/or
the first transmission power configuration includes a first power offset for a first UL message in the first UL resource in addition to a transmission power of a first UL message out of the first UL resource; and/or
the first transmission power configuration includes a PRACH target reception power having a second power offset for a first UL message in the first UL resource than a first UL message out of the first UL resource; and/or
the first transmission power configuration includes a first target reception power value for a first UL message in the first UL resource and a second target reception power value for a first UL message out of the first UL resource; and/or
the first transmission power configuration includes a first Delta_Preamble setting for a first UL message in the first UL resource and a second Delta_Preamble setting for a first UL message out of the first UL resource; and/or
the first transmission power configuration is indicated by a PDCCH with an offset value for the first UL message in the first UL resource.

5. (canceled)

6. The method of claim 4, wherein the first power ramping setting includes at least one of a power ramping counter or a power ramping step size for the first UL message.

7. The method of claim 4, further comprising, determining a power ramping value for a first UL message according to the power ramping setting corresponding to a resource for the first UL message.

8. The method of claim 1, further comprising selecting a first RACH occasion (RO) and at least one second RO for different RACH attempts, wherein whether the at least one second RO is within or out of a first UL resource is based on whether the first RO is within or out of a first UL resource.

9. The method of claim 1, further comprising selecting at least one SSB (Synchronization Signal Block) based on an SSB selection configuration, the SSB selection configuration including a first threshold for selecting of an SSB corresponding to an RO within the first UL resource and a second threshold for selection of an SSB corresponding to an RO out of the first UL resource.

10. The method of claim 1, further comprising determining a transmission power of a second UL message based on the transmission power of the first UL message and a second transmission power configuration, wherein:
the second transmission power configuration includes two or more values of power difference between the first UL message and the second UL message; and/or
the second transmission power configuration includes a value of power difference between the first UL message and the second UL message and one or more offset.

11. The method of claim 10, wherein the second UL message is a PUSCH message.

12. A wireless communication method, comprising:
providing a first transmission power configuration; and
receiving a first uplink (UL) message having a transmission power determined based on the first power configuration and whether the first UL message is in a first UL resource.

13. The method of claim 12, wherein the first UL resource occupies at least a part of a frequency domain resource of a downlink (DL) resource or a flexible resource; and/or
the first UL message is a preamble transmitted on a Physical Random Access Channel (PRACH).

14. The method of claim 12, wherein, according to the first transmission power configuration, the first UL message has a first transmission power when it is in the first UL resource different from a second transmission power when it is out of the first UL resource.

15. The method of claim 12, wherein:
the first transmission power configuration includes a first power ramping setting for a first UL message in the first UL resource and a second power ramping setting for a first UL message out of the first UL resource; and/or
the first transmission power configuration includes a first power offset for a first UL message in the first UL resource in addition to a transmission power of a first UL message out of the first UL resource; and/or
the first transmission power configuration includes a PRACH target reception power having a second power offset for a first UL message in the first UL resource than a first UL message out of the first UL resource; and/or
the first transmission power configuration includes a first target reception power value for a first UL message in the first UL resource and a second target reception power value for a first UL message out of the first UL resource; and/or
the first transmission power configuration includes a first Delta_Preamble setting for a first UL message in the first UL resource and a second Delta_Preamble setting for a first UL message out of the first UL resource; and/or
the first transmission power configuration is indicated by a PDCCH with an offset value for the first UL message in the first UL resource.

16. (canceled)

17. The method of claim 15, wherein the first power ramping setting includes at least one of a power ramping counter or a power ramping step size for the first UL message.

18. The method of claim 15, further comprising receiving the first UL message have the transmission power determined according to a power ramping value for the first UL message according to the power ramping setting corresponding to a resource for the first UL message.

19. The method of claim 12, further comprising receiving the first UL message in a first RACH occasion (RO) and at least one second RO for different RACH attempts, wherein whether the at least one second RO is within or out of a first UL resource is based on whether the first RO is within or out of a first UL resource.

20. The method of claim 12, further comprising an SSB selection configuration for selecting at least one SSB (Synchronization Signal Block) providing, the SSB selection configuration including a first threshold for selecting of an SSB corresponding to an RO within the first UL resource and a second threshold for selection of an SSB corresponding to an RO out of the first UL resource.

21. The method of claim 12, further comprising receiving a second UL message having a transmission power determined based on the transmission power of the first UL message and a second transmission power configuration, wherein:
the second transmission power configuration includes two or more values of power difference between the first UL message and the second UL message; and/or
the second transmission power configuration includes a value of power difference between the first UL message and the second UL message and one or more offset.

22. (canceled)

23. A wireless communication apparatus, comprising one or more memory units storing one or more programs and one or more processors electrically coupled to the one or more memory units and configured to execute the one or more programs to perform:
obtaining or providing a first transmission power configuration; and
determining or receiving a transmission power of a first uplink (UL) message based on the first power configuration and whether the first UL message is in a first UL resource.

24. (canceled)
